(19) United States
(12) Patent Application Publication
(10) Pub. No.: US 2015/0111115 A1
(43) Pub. Date: Apr. 23, 2015

(54) METAL-AIR BATTERY

(71) Applicant: TOYOTA JIDOSHA KABUSHIKI KAISHA, Toyota-shi (JP)

(72) Inventor: Iwao NITTA, Susono-shi (JP)

(21) Appl. No.: 14/483,540

(22) Filed: Sep. 11, 2014

(30) Foreign Application Priority Data
Oct. 18, 2013 (JP) 2013-217300

(51) Int. Cl. H01M 12/02; H01M 4/62; H01M 4/38

(52) U.S. Cl. CPC H01M 12/02; H01M 4/38; H01M 4/62
USPC 429/406; 429/403; 429/405

(57) ABSTRACT

Provided is a metal-air battery capable of inhibiting deterioration of battery performance. The metal-air battery includes an anode, a cathode, an electrolyte disposed between the anode and the cathode, and a housing configured to house the anode, the cathode, and the electrolyte, wherein the anode is capable of being ejected from the housing and the anode includes an anode active material, a carbon dioxide absorbent, and an electroconductive holding body configured to hold the anode active material and the carbon dioxide absorbent.

### BACKGROUND OF THE INVENTION

1. Field of the Invention

The present invention relates to a metal-air battery.

2. Description of the Related Art

An air battery which employs oxygen for a cathode active material has a lot of advantages such that the battery has a high energy density. As the air battery, metal-air batteries such as iron-air batteries and zinc-air batteries are known. The metal-air battery generally includes: an air electrode (cathode) including an electroconductive material (for example, a carbon material) and a binder; an anode including an anode active material (such as a metal and alloy); and an electrolyte interposed between the air electrode and the anode. In a case where a liquid electrolyte (an electrolytic solution) is employed, the electrolytic solution is disposed between the air electrode and the anode with a separator which is an insulating porous body immersed with the electrolytic solution.

As a technique related to the air battery as above, for example, Patent Document 1 discloses a technique to add a carbon dioxide absorbent to an air electrode in a zinc-air battery including a zinc anode and the air electrode provided with a cathode material filled in a metal mesh, the cathode material including metal oxide, graphite, activated carbon and fluorine-based binder agent as main components. Patent Document 2 discloses an air battery including a carbon dioxide absorbent between an air electrode and a cathode case provided with an air hole(s). Patent Document 3 discloses a technique to dispose a carbon dioxide absorbent incorporating a resin film between a surface of water-repellent membrane of an air electrode and a diffusion paper in an air battery including the diffusion paper and the air electrode having a structure that the water-repellent membrane is stuck together with a catalytic sheet in which a cathode catalytic layer including oxidation metal, graphite, activated carbon and fluorine-based binder agent as main components is joined to a current collector. Patent Document 4 discloses an air battery including a carbon dioxide absorbing body disposed between an air electrode and a cathode case provided with an air hole(s), the carbon dioxide absorbing body consisting of a porous body whose surface layer is a resin film provided with pores and whose inner surface layer is immersed with a carbon dioxide absorbent. Patent Document 5 discloses a button type air battery including a cathode catalytic layer and a water-repellent membrane disposed on an air diffusing side of the cathode catalytic layer, wherein the cathode catalytic layer and the water-repellent membrane are in a cathode case provided with an air supplying hole(s) on its bottom surface, and a carbon dioxide absorbing layer is provided between the water-repellent membrane and the air supplying hole(s).

### CITATION LIST

### Patent Literatures

Patent Document 1: Japanese Patent Application Laid-Open No. 2000-3735
Patent Document 2: Japanese Patent Application Laid-Open No. 2007-141745
Patent Document 3: Japanese Patent Application Laid-Open No. 2005-26144
Patent Document 4: Japanese Patent Application Laid-Open No. H07-37624
Patent Document 5: Japanese Patent Application Laid-Open No. S62-272478

### SUMMARY OF THE INVENTION

### Problems to be Solved by the Invention

With the conventional techniques disclosed in Patent documents 1 to 5, since a carbon dioxide absorbent is employed, it can be considered that carbon dioxide entered in the air battery can be reduced. However, in these techniques, the carbon dioxide absorbent is disposed on a side of the air electrode (cathode). The carbon dioxide absorbent is considered to expand by absorbing carbon dioxide. Therefore, if the carbon dioxide absorbent is disposed on the side of the air electrode, there is a possibility that the air electrode breaks when the carbon dioxide absorbent expands. Since there is a possibility that oxygen is prevented from being supplied if the air electrode breaks, the performances of air battery possibly deteriorate with the conventional techniques. Also, in a metal-air primary battery for example, since its anode active material deteriorates due to reaction, the anode active material is changed out in order to keep the battery performance at a certain level or above. Here, a configuration in which an electrolyte and an air electrode are also changed out in changing out the anode active material can be considered. However, if the electrolyte and the air electrode are also changed out, it means a lot of constituent parts of the metal-air primary battery need to be changed out, thus the cost easily increases. Therefore, in view of inhibiting increase in cost, it is preferred that the air electrode is not changed out. If the techniques disclosed in Patent Documents 1 to 5 are applied to a metal-air battery in which the air electrode is not changed out, since the carbon dioxide absorbent is not changed out, ability to absorb carbon oxide easily decreases as time passing. If the ability to absorb carbon dioxide decreases, a carbonated compound is generated due to reaction of ions contained in the electrolytic solution and the carbon dioxide for example. If this carbonated compound blocks the pores of the air electrode, air supply is prevented. Further, the battery performance tends to deteriorate since occurrence frequency of electrochemical reaction in the anode is degraded when the ions contained in the electrolytic solution is reduced by being used for forming reaction of the carbonated component. That is, in the techniques disclosed in Patent Documents 1 to 5, there is a problem that the battery performance easily deteriorates.

Accordingly, an object of the present invention is to provide a metal-air battery capable of inhibiting deterioration of battery performance.

### Means for Solving the Problems

As a result of an intensive study, the inventor of the present invention has found out that it is possible to inhibit deterioration of battery performance by containing a carbon dioxide absorbent to an anode of a metal-air battery which is capable of being ejected from the metal-air battery, since the carbon dioxide absorbent can be collected when the anode is changed out. The present invention has been made based on the above finding.

The present invention has the following means to solve the above problems. That is, the present invention is a metal-air battery including an anode, a cathode, an electrolyte disposed between the anode and the cathode, and a housing configured to house the anode, the cathode, and the electrolyte, wherein the anode is capable of being ejected from the housing and the anode includes an anode active material, a carbon dioxide absorbent, and an electroconductive holding body configured to hold the anode active material and the carbon dioxide absorbent.

The carbon dioxide absorbent can be ejected from the housing together with the anode active material from the metal-air battery configured as above. By ejecting the carbon dioxide absorbent, the carbon dioxide absorbent whose ability to absorb carbon dioxide is deteriorated can be changed to a carbon dioxide absorbent whose ability to absorb carbon dioxide is not deteriorated. Therefore it is possible to keep the ability to absorb carbon dioxide at a certain level or above. By keeping the ability to absorb carbon dioxide at a certain level or above, it is possible to inhibit generation of carbonated compound inside the metal-air battery, whereby it is possible to inhibit deterioration of the battery performance.

Also, in the present invention, it is preferred that the carbon dioxide absorbent is one or two or more substance(s) selected from the group consisting of MgO, soda limes, soda-asbestos, Li₂ZrO₃, Li₄SiO₄, calcium oxide, hydrotalcite-like compounds, zeolites, metal-organic frameworks (MOF), Li₂O, and Na₂O. This configuration makes it possible to easily obtain a metal-air battery capable of inhibiting deterioration of battery performance.

In the present invention, it is also possible that the carbon oxide absorbent is one or two or more substance (s) selected from the group consisting of lithium hydroxide, calcium hydroxide, and sodium hydroxide, and the electrolyte is a substance different from the carbon dioxide absorbent. This configuration also makes it possible to easily obtain a metal-air battery capable of inhibiting deterioration of battery performance.

In the present invention, it is also possible that the carbon dioxide absorbent is one or two or more substance(s) selected from the group consisting of lithium hydroxide, calcium hydroxide, and sodium hydroxide, the electrolyte includes a same substance as the carbon dioxide absorbent, and the amount of salt dissolved in the electrolyte is over saturated. This configuration also makes it possible to obtain a metal-air battery capable of inhibiting deterioration of battery performance.

In the present invention, it is preferred that the anode active material includes at least one or more selected from the group consisting of Fe, Zn, Pb, Sn, Cd, Al, Mg, and Ca. This configuration makes it possible to obtain a metal-air battery capable of inhibiting deterioration of battery performance.

In the present invention, it is preferred that the electrolyte is an aqueous electrolytic solution and the aqueous electrolytic solution contains an electrolyte salt selected from the group consisting of LiOH, KOH, NaOH, RbOH, CsOH, Ca(OH)₂ and Sr(OH)₂. This configuration makes it possible to obtain a metal-air battery capable of inhibiting deterioration of battery performance.

Also, in the present invention, oxygen can be employed as a cathode active material for making electrochemical reaction in the cathode. This configuration makes it possible to easily obtain a metal-air battery capable of inhibiting deterioration of battery performance.

### Effects of the Invention

According to the present invention, it is possible to provide a metal-air battery capable of inhibiting deterioration of battery performance.

### BRIEF DESCRIPTION OF THE DRAWINGS

FIG. 1 is a cross-sectional view to explain a metal-air battery of the present invention;

FIG. 2 is a figure to explain an anode 11;

FIG. 3 is a figure to explain an anode 21;

FIG. 4 is a cross-sectional view to explain a metal-air battery of the present invention.

### DETAILED DESCRIPTION OF THE INVENTION

Hereinafter, the present invention will be described with reference to the drawings. In the following drawings, repeated symbols are sometimes partly omitted. It should be noted that the embodiments shown below are examples of the present invention and the present invention is not limited to the embodiments.

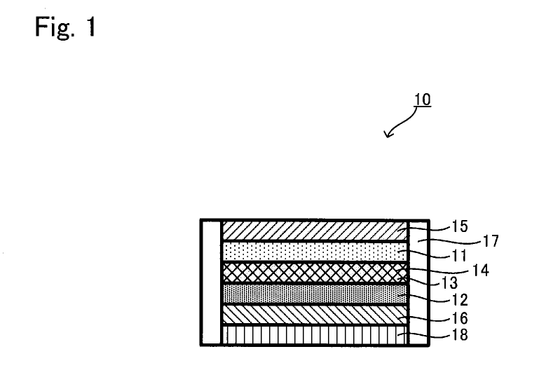

FIG. 1 is a cross-sectional view to explain a metal-air battery of the present invention. FIG. 1 shows an iron-air primary battery 10 (hereinafter sometimes simply referred to as “battery 10”) which is one embodiment of the metal-air battery of the present invention. In FIG. 1, the battery 10 is shown being simplified. As shown in FIG. 1, the battery 10 includes an anode 11 containing iron which functions as an anode active material, a cathode 12, a separator 14 disposed between the anode 11 and the cathode 12, the separator 14 holding an electrolyte 13 disposed between the anode 11 and the cathode 12, an anode current collector 15 connected to the anode 11, a cathode current collector 16 connected to the cathode 12, and a housing 17 which houses the anode 11, the cathode 12, the separator 14, the anode current collector 15, and the cathode current collector 16, wherein a part of the housing 17 consists of a water-repellent membrane 18. The anode 11 is formed into a sheet, and configured to be able to be ejected from the housing 17. The cathode 12 has a configuration in which a catalyst which allows oxygen (cathode active material) in the cathode 12 to react easily is held by an electroconductive member by means of a binding agent. The electrolyte 13 is an electrolytic solution (hereinafter sometimes referred to as “the electrolytic solution 13”) containing KOH. The separator 14 is a porous member made of resin, the separator 14 having cavities and pores capable of holding the electrolytic solution 13. The anode current collector 15 and the cathode current collector 16 are used when electricity is taken out and the like. Also, the housing 17 is configured such that air existing around the housing 17 can be diffused to the cathode 12, via the water-repellent membrane 18 configuring a part of the housing 17. The battery 10 is, by means of the water-repellent membrane 18 and the like, configured such that the electrolytic solution 13 does not leak from the housing 17.

When the battery 10 is operated by bringing oxygen included in the air to the cathode 12 to generate a discharge reaction, a reaction represented by the following Formula (1) occurs in the anode 11, and a reaction represented by the following Formula (2) occurs in the cathode 12.

Fe+20H⁻→Fe(OH)₂+2e⁻ (1)

½O₂+H₂O+2e⁻→2OH⁻ (2)

Here, the air contains carbon dioxide. Therefore, with a state in which oxygen can reach the cathode 12, carbon dioxide starts to mix in the electrolytic solution 13. As a result, a reaction represented by the following Formula (3) can occur.

2KOH+CO₂→K₂CO₃+H₂O (3)

When potassium carbonate generated by the reaction represented by the above Formula (3) deposits in the cathode 12, there is a possibility that the potassium carbonate blocks the channel of oxygen to be diffused to the cathode 12. If oxygen supply is prevented due to blocking of the channel of oxygen, the reaction represented by the above Formula (2) becomes difficult to occur, whereby the performance of the battery 10 deteriorates. In the present invention, a carbon dioxide absorbent (hereinafter sometimes referred to as “CO₂ absorbent”) is contained to the anode 11 in order to prevent a situation like this.

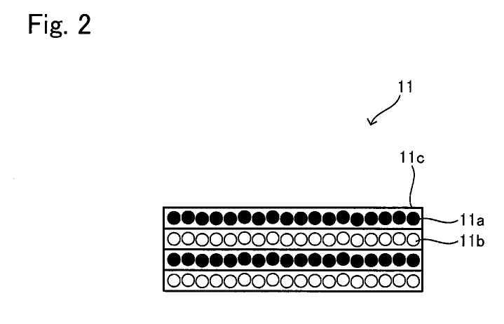

FIG. 2 is a figure to explain an anode 11. In order to make the disposition of an anode active material 11a and a CO₂ absorbent 11b easy to understand, the shape of an electroconductive holding body 11c is shown being simplified in FIG. 2. As shown in FIG. 2, the anode 11 includes the anode active material 11a, the CO₂ absorbent 11b, and the electroconductive holding body 11c holding the anode active material and the CO₂ absorbent. The anode active material 11a is iron powder, and the CO₂ absorbent 11b is MgO particles. The electroconductive holding body 11c is an electroconductive member provided with pores to bring OH⁻ existing in the electrolytic solution 13 to the anode active material 11a and holding the anode active material 11a and the CO₂ absorbent 11b.

As shown in FIG. 1, the anode 11 has contact with the electrolytic solution 13. Therefore, in the battery 10, the CO₂ absorbent 11b and carbon dioxide mixed in the electrolytic solution 13 have contact with each other. As a result, reactions represented by the following Formula (4) and Formula (5) occur.

MgO+H₂O→Mg(OH)₂ (4)

Mg(OH)₂+CO₂→MgCO₃ (5)

As shown above, according to the battery 10, it is possible to absorb (reduce) the carbon dioxide mixed in the electrolytic solution 13 by means of the CO₂ absorbent 11b contained in the anode 11. By absorbing the carbon dioxide mixed in the electrolytic solution 13, it is possible to inhibit the reaction represented by the above Formula (3). Therefore, according to the present invention, it is possible to provide the battery 10 capable of inhibiting deterioration of battery performance.

As shown in Formulas (4) and (5), the CO₂ absorbent 11b is changed from the original form (MgO) to magnesium carbonate by absorbing carbon dioxide. Therefore, as the carbon dioxide is absorbed, remaining amount of the CO₂ absorbent 11b which has not absorbed carbon dioxide is reduced. As described above, since the ability of the co₂ absorbent 11b included in the anode 11 to absorb carbon dioxide has a limitation, it is considered that the ability of the CO₂ absorbent 11b included in the anode 11 to absorb carbon dioxide deteriorates as the carbon dioxide is absorbed.

On the other hand, as shown by Formula (1), the anode active material 11a changes to another substance when the discharge reaction occurs. Therefore, in order to keep the performance of the battery 10 at a certain level or above, it is desired that the anode active material (hereinafter, the anode active material is sometimes referred to as “anode active material 11a′”) whose state is changed from the original state is changed out before the reaction represented by Formula (1) becomes difficult to occur. From this viewpoint, in the battery 10, the anode including the anode active material 11a′ and the CO₂ absorbent whose state is changed from the original state (hereinafter, the CO₂ absorbent is sometimes referred to as “CO₂ absorbent 11b′”) is configured such that the anode 11 can be ejected from the housing 17. According to the battery 10, when the anode 11′ is ejected from the housing 17 in order to change out the anode active material 11a′, the CO₂ absorbent 11b′ can also be ejected from the housing 17. As described above, after the anode 11′ is ejected from the housing 17, in place of the anode 11′, the anode 11 including the anode active material 11a, the CO₂ absorbent 11b, and the electroconductive holding body 11c is put in the housing 17. Changing the anode 11′ to the anode 11 makes the reactions represented by the above formulas (1), (4), and (5) easy to occur. Therefore, according to the present invention, it is possible to inhibit deterioration in performance of the battery 10.

In contrast, in the conventional technique in which a CO₂ absorbent is disposed to a cathode side, which is different from the present invention, it is considered that the cathode is changed out in order to keep the ability to absorb carbon dioxide at a certain level or above. As described above, since an anode is changed out in order to change out an anode active material in the iron-air primary battery, in the conventional technique in which the cathode is changed out, it is needed to change out the cathode and the anode. In the configuration in which the cathode and the anode are changed out, required time for changing work tends to be long, whereby cost for changing out tends to increase. In order to solve such problems, the present invention has a configuration in which the carbon dioxide absorbent is provided to the anode. By providing the carbon dioxide absorbent to the anode, it becomes no need to change out the cathode, which makes it possible to shorten the required time for changing work and reduce cost for changing out.

In addition to this, as a technique of preventing carbon dioxide from being mixed to the electrolytic solution, a configuration in which a carbon dioxide absorbing apparatus (CO₂ scrubber) including a bath in which an alkaline substance is filled is employed, a configuration in which an oxygen-permeable membrane is employed and the like can be applied. With the configuration in which a carbon dioxide absorbing apparatus is applied, it is considered that the reaction represented by the above Formula (3) can be inhibited. However, in this configuration, since the carbon dioxide absorbing apparatus is used together with a battery, volume energy density of the battery tends to deteriorate. In contrast, since the present invention has a configuration in which the CO₂ absorbent 11b is provided to the anode 11 which is a constituent part of the battery 10, it is possible to increase volume energy density of the battery 10 compared with the configuration in which the carbon dioxide absorbing apparatus is applied. Also, in the configuration in which a conventional oxygen-permeable membrane is applied, the battery performance tends to deteriorate because of low oxygen permeability. Further, since it is virtually impossible to perfectly prevent permeation of carbon dioxide with the configuration, it is considered that the reaction represented by the above Formula (3) is difficult to be inhibited.

In the present invention, a method for ejecting the anode 11′ from the housing 17 is not particularly limited, and a known method can be applied. For example, the anode 11′ can be ejected with a state in which the battery 10 is attached to a device which uses the battery 10, or the anode 11′ can be ejected from the battery 10 after the battery 10 is removed from the device. As a specific way of ejecting the anode 11′, configurations such as pulling out the anode 11′ from the housing 17, and peeling off the anode 11′ from the anode current collector 15 after the anode current collector and the anode 11′ are ejected from the housing 17 can be exemplified.

In the present invention, a method for changing the anode 11′ to the anode 11 is not particularly limited and any appropriate configuration can be adequately chosen with consideration of effect to the environment, cost and the like comprehensively. For example, the following configuration can be applied in which: after changing the anode 11′ to the anode 11, the anode active material 11a′ and the CO₂ absorbent 11b′ are separately collected from the anode 11′; followed by regenerating the anode active material 11a′ to the anode active material 11a, together with regenerating the co₂ absorbent 11b′ to the CO₂ absorbent 11b; thereafter the regenerated anode active material 11a and regenerated CO₂ absorbent 11b are reused. In addition to this, for example, the following configuration can also be applied: the anode active material 11a′ and the CO₂ absorbent 11b′ from the anode 11′ are separately collected from the anode 11′; followed by regenerating the anode active material 11a′ to the anode active material 11a, whereas not regenerating the CO₂ absorbent 11b′ to reuse, but filling the electroconductive holding body 11c with new CO₂ absorbent 11b.

A method for separately collecting the anode active material 11a′ and the CO₂ absorbent 11b′ from the anode 11′ is not particularly limited, and a known method can be applied. In the present invention, for example, using the difference in solubility of each metal (Fe of the anode active material 11a′ and Mg of the CO₂ absorbent 11b′) from an electric potential-pH diagram, it is possible to selectively dissolve either one of the metals and extract the other one. Besides, it is also possible to deposit the CO₂ absorbent 11b′ to separate it from the anode active material 11a′ by immersing the anode 11′ with a lower alcohol represented by ethanol.

Also, a method for regenerating the anode active material 11a′ to the anode active material 11a and a method for regenerating the CO₂ absorbent 11b′ to the CO₂ absorbent 11b are not particularly limited. As the method for regenerating the anode active material 11a′ to the anode active material 11a, a configuration in which a heat treatment (reducing heat treatment) is carried out by means of a heat treatment furnace in which a reducing atmosphere is made; whereby regenerating the anode active material 11a′ to the anode active material 11a and the like can be exemplified. Also, as the method for regenerating the CO₂ absorbent 11b′ to the CO₂ absorbent 11b, the following configuration in which: after making the reaction represented by the following Formula (6) by immersing the CO₂ absorbent 11b′ with water, a heat treatment (reducing heat treatment) is carried out to the magnesium hydroxide generated by the reaction, by means of a heat treatment furnace in which a reducing atmosphere is made; thereby regenerating the CO₂ absorbent 11b′ to the CO₂ absorbent 11b and the like can be exemplified.

MgCO₃+H₂O→Mg(OH)₂+CO₂ (6)

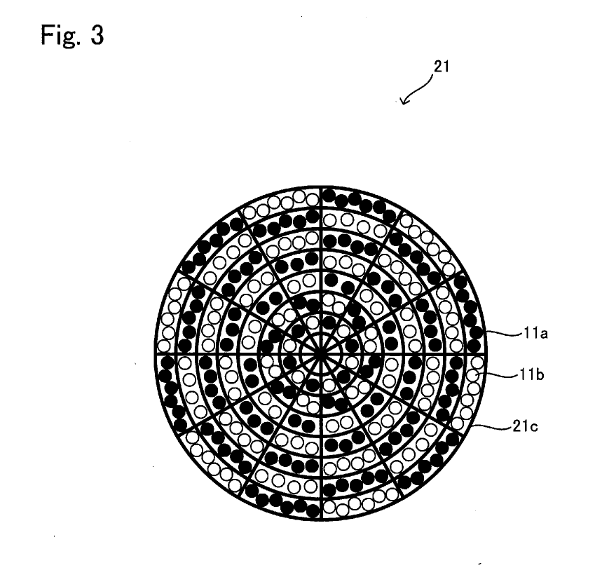

In the above explanation according to the present invention, the anode 11 made into a sheet is exemplified. However, the configuration of the anode which can be used in the present invention is not limited to this. An anode 21 having another configuration is shown in FIG. 3.

FIG. 3 is a top view to explain the configuration of the anode 21 which can be used in the present invention. In FIG. 3, same symbols used in FIG. 2 are applied to what configured in the same way as in the constituent parts shown in FIG. 2, and explanation thereof will be adequately omitted. In order to make the disposition of the anode active material 11a and the CO₂ absorbent 11b easy to understand, the shape of the electroconductive holding body 21c is shown being simplified in FIG. 3.

As shown in FIG. 3, the anode 21 has a substantially tubular shape, and when seen from the upper surface, it has a round shape. The anode 21 includes the anode active material 11a, the CO₂ absorbent 11b, and an electroconductive holding body 21c holding the anode active material 11a and the CO₂ absorbent 11b. The electroconductive holding body 21c is an electroconductive member provided with pores to bring OH⁻ existing in the electrolyte of a metal-air battery in which the anode 21 is to be used, to the anode active material 11a, and holding the anode active material 11a and the CO₂ absorbent 11b. With the anode 21 having a configuration as above, since the anode active material 11a and the CO₂ absorbent 11b can be ejected at the same time when the anode 21 is ejected, it is possible to exert a same effect as with the battery 10 provided with the anode 11.

In the above explanation according to the present invention, the anode 11 and the anode 21 each having a configuration in which the anode active material 11a and CO₂ absorbent 11b are alternately disposed when seen from one direction. However, the anode to be used to the metal-air battery of the present invention is not limited to this configuration. Any configurations can be applied to the anode in the present invention, as long as the anode includes an anode active material, a CO₂ absorbent, and an electroconductive holding body holding the anode active material and the CO₂ absorbent. The anode can also have a configuration in which the anode active material and the CO₂ absorbent are not alternately disposed when seen from any directions. However, in view of having a configuration in which the number of anode active materials to be used to the reaction to make electrons is easily increased and the like, it is preferred that a lot of anode active materials are disposed without being agglutinated. Also, even in a case where the CO₂ absorbent is expanded by absorbing carbon dioxide, in view of making a configuration in which the electroconductive holding body is difficult to break and the like, it is preferred that the anode active material and the CO₂ absorbent are not agglutinated respectively, but disposed being evenly distributed. From this viewpoint, the anode in the present invention preferably has a configuration in which the anode active material and CO₂ absorbent are alternately disposed.

In the present invention, a method for disposing the anode active material and the CO₂ absorbent such that they are alternately disposed when the anode is seen from one direction is not particularly limited. The anode 11 shown in FIG. 2 and the anode 21 shown in FIG. 3 can be produced by, for example, going through a step of alternately laminating a part of the electroconductive holding body filled with the anode active material 11a (a portion in the electroconductive holding body, where the anode active material 11a is filled) and a part of the electroconductive holding body filled with the CO₂ absorbent 11b (a portion in the electroconductive holding body, where the CO₂ absorbent 11b is filled). Also, arrangement of the anode active material (to dispose the anode active material to the position where the anode active material is to be disposed) can be controlled by means of a member such as a filter in which a hole is made to the position where is to be filled with the anode active material but no hole is made to the place where is not to be filled with the anode active material. Also, the

CO₂ absorbent can be disposed to the electroconductive holding body by means of the following method for example.

The electroconductive holding body in which the position where is to be filled with the anode active material is filled with the anode active material by means of the above method and the like is immersed with an aqueous solution of Mg salt for example. Thereafter, the immersed anode active material is made to go through a reaction with a basic aqueous solution such as sodium hydroxide, whereby Mg(OH)₂ is precipitated to the electroconductive holding body. Next, the electroconductive holding body where Mg(OH)₂ is precipitated is dried and made to go through a heat treatment under air atmosphere, whereby it is possible to dispose MgO particle (CO₂ absorbent) in the electroconductive holding body. In addition to this, with the following method as well for example, it is possible to dispose the anode active material to a position where the anode active material is to be disposed and dispose the CO₂ absorbent to a position where the CO₂ absorbent is to be disposed: reversing the above order, after portions inside the electroconductive holding body where the anode active material and the CO₂ absorbent are to be disposed are filled with a gel form of Mg(OH)₂, the electroconductive holding body with the Mg(OH)₂ is dried and made to go through a heat treatment under air atmosphere, thereby disposing MgO particle (CO₂ absorbent); thereafter, the anode active material is selectively put in a position where the anode active material is to be disposed inside the electroconductive holding body by means of the above filter and the like, and at the same time, the CO₂ absorbent in a position where the anode active material is to be disposed is pushed out.

In the present invention, a known metal which can be used for a metal-air battery can be adequately applied as the anode active material. The anode active material preferably includes at least one or more selected from the group consisting of Fe, Zn, Pb, Sn, Cd, Al, Mg, and Ca, and particularly, it is preferable to include Fe or Zn. In a case where Fe or Zn is contained in the anode active material, when a ratio of mass of Fe or Zn to the total mass of the anode active material is defined as x [wt %], the ratio is preferably 10<x≦100, more preferably 30<x≦100, and especially preferably 50<x≦100.

The configuration of the anode active material is not particularly limited. An anode active material having a known configuration such as an anode active material having a particle shape, an anode active material having a sheet shape and the like can be adequately employed. In view of making a configuration in which the performance of the metal-air battery is easy to be increased, the anode active material preferably has a particle shape. In a case where the anode active material having a particle shape is employed, size of the anode active material is not particularly limited, and for example, an anode active material having a particle shape whose diameter is 100 nm or more can be employed. Also, an anode active material having a particle shape whose diameter is 1 mm or less can be employed. In a case where an anode active material having a particle shape is employed, the diameter of the particle can be adequately determined with comprehensive consideration of the performance of the metal-air battery, manufacturing cost and the like.

Also, as the carbon dioxide absorbent, a known substance having the properties of (1) not reacting with the anode active material, the cathode active material, or the electrolyte in the metal-air battery, and (2) being capable of reducing carbon dioxide in the metal-air battery by reacting and absorbing the carbon dioxide can be adequately employed. As such a substance, MgO, soda lime, lithium hydroxide, soda-asbestos, Li₂ZrO₃, Li₄SiO₄, calcium oxide, calcium hydroxide, sodium hydroxide, hydrotalcite-like compounds, zeolites, metal-organic frameworks (MOF), Li₂O, Na₂O and the like can be exemplified. Here, the term “hydrotalcite-like compounds” is a collective name of compounds represented by a general formula of M²⁺₁₋xM⁺ₓ(OH)₂Aⁿ⁻_{x/n}.mH₂O(M²⁺ is a divalent metal ion, M³⁺ is a triad metal ion, Aⁿ⁻ is anion of n valence, and 0<x<1). As the hydrotalcite-like compounds which can be used as the carbon dioxide absorbent in the present invention, Mg₆Al₁₂ (OH)₁₆CO₃. 4H₂O and the like can be exemplified. The metal-organic frameworks (MOF) are also called as a porous coordination polymer (PCP). As the metal-organic frameworks (MOF) which can be used as the carbon dioxide absorbent in the present invention, Cu₂(pzdc)₂L (pzdc:2,3-pyrazinedicarboxylate, L=dipyridyl-based ligand) and the like can be exemplified.

In the present invention, in cases where the carbon dioxide absorbent is one or two or more substance(s) selected from the group consisting of lithium hydroxide, calcium hydroxide, and sodium hydroxide, as an electrolyte salt, a substance which is different from the carbon dioxide absorbent can be used, and a substance which is same as the carbon dioxide absorbent can also be used. However, in a case where one or two or more substance(s) selected from the group consisting of lithium hydroxide, calcium hydroxide, and sodium hydroxide is (are) used as the carbon dioxide absorbent, and a same substance as the carbon dioxide absorbent is included in the electrolyte salt to be contained in the electrolyte, the amount of salt dissolved in the electrolyte is made to be over saturated. In other words, when a same substance as the carbon dioxide absorbent is included in the electrolyte salt to be contained in the electrolyte, the carbon dioxide absorbent is added to the electrolyte until it becomes over saturated. By making a configuration as above, even when a same substance is used for the carbon dioxide and the electrolyte salt, it becomes possible to hold a part of the electrolyte salt in the solid state inside the electrolytic solution. As a result, it becomes possible to make the electrolyte salt in the solid state function as the carbon dioxide absorbent.

Also, in the present invention, in a case where an aqueous electrolyte solution is used as the electrolyte, when a substance which dissolves in water such as Li₂O and Na₂O is used as the carbon dioxide absorbent besides lithium hydroxide, calcium hydroxide, and sodium hydroxide, the carbon dioxide absorbent (hereinafter sometimes referred to as “soluble carbon dioxide absorbent”) which dissolves in water is dissolved in the electrolytic solution until it becomes over saturated. At this time, in a case where a substance different from the soluble carbon dioxide absorbent is used as the electrolyte salt, since the electrolyte salt also exists being dissolved in the aqueous electrolyte solution, it is considered that the dissolving amount of the soluble carbon dioxide absorbent is changed. Therefore, in such a case, it is preferred that the additive amount of the soluble carbon dioxide absorbent to be added to the aqueous electrolyte solution is adequately adjusted.

The configuration of the carbon dioxide absorbent is not particularly limited and a carbon dioxide absorbent having a known configuration such as carbon dioxide absorbent having a particle shape, sheet shape and the like can be adequately employed. However, in view of making a configuration in which the carbon dioxide absorbent performance is easy to be increased and a space is easy to be ensured around the carbon dioxide absorbent where is to be taken up by the carbon dioxide absorbent when the carbon dioxide absorbent is expanded, the carbon dioxide absorbent preferably has a particle shape. In a case where the carbon dioxide absorbent having a particle shape is applied, size of the particle is not particularly limited. For example, a carbon dioxide absorbent having a particle shape whose diameter is 100 nm or more can be employed. Also, a carbon dioxide absorbent having a particle shape whose diameter is 1 mm or less can be employed. In a case where the carbon dioxide absorbent having a particle shape is employed, the diameter can be adequately determined with comprehensive consideration of the performance of absorbing carbon dioxide, manufacturing cost and the like.

The configuration of the electroconductive holding body is not particularly limited as long as the electroconductive holding body has properties of (1) having an electrical conductivity, (2) having holes where ions can go through, and (3) being capable of holding the anode active material and the carbon dioxide absorbent. The electroconductive holding body is, in addition to the above properties, preferably (4) configured by a substance which does not react with the anode active material, the carbon dioxide absorbent, or the electrolyte inside the metal-air battery. In addition, it is preferred that (5) the electroconductive holding body is capable of keeping its structure by reducing change in volume associated with oxidation of the carbon dioxide absorbent and the anode active material (for example, Fe+20H⁻→Fe(OH)₂+2e⁻). For the electroconductive holding body, for example, materials which can be used for an anode current collector of a metal-air battery and the like can be employed. In the present invention, for example, it is preferred that the electroconductive holding body is made of materials such as an electroconductive material having a metal layer (covering film) containing at least one selected from the group consisting of Ni, Cr, and Al formed on its surface, and a metal material whose entire body consists of a metal containing at least one or more selected from the group consisting of Ni, Cr, and Al. The electroconductive holding body can be made of a foamed metal for example, and in addition to this, it can be made with an electroconductive material formed in mesh/net.

Also, the configuration of the cathode is not particularly limited, and a known configuration which can be employed for the cathode of a metal-air battery can be chosen. For example, a configuration in which a catalyst and a binder agent are held in a metal body can be applied. The metal body of the cathode can have a known configuration in which the metal body can be used as a holding body of catalyst in a cathode of a metal-air battery. The metal body can be made of a known metal which is stable to an electrolytic solution. In specific, for example, the metal body can be configured by a metal provided with a metal layer (covering film) formed on its surface, the metal layer containing at least one or more selected from the group of Ni, Cr, and Al, or can be configured by a metal material whose entire body consists of a metal containing at least one or more selected from the group consisting of Ni, Cr, and Al. A known configuration such as a metal mesh, a metallic foil to which a pierce processing is applied, and a foamed metallic body can be applied to the metal body.

A known catalyst having an oxygen reduction capacity which can be used for a metal-air battery can be used as a catalyst to be held by the metal body. As such a catalyst, carbon blacks, Ketjen blacks, carbon nanotubes, carbon nanofibers and the like can be exemplified, and a configuration in which the catalyst is supported on a surface of carbon is preferred. As the catalyst to be held on the surface of the carbon, for example, platinum group elements such as Ni, Pd, and Pt; perovskite oxides including transition metals such as Co, Mn, and Fe; inorganic compounds including noble metal oxides such as Ru, Ir, and Pd; metal coordination organic compounds having porphyrin skeleton or phthalocyanine skeleton; inorganic ceramics such as manganese dioxide (MnO₂), cerium oxide (CeO₂) and the like; complex materials in which these materials are mixed and the like can be exemplified.

A known binder which can be used for a metal-air battery can be adequately applied to the binder to be held to the metal body with the catalyst. As the binder, polyvinylidene fluoride (PVDF), polytetrafluoroethylene (PTFE), styrene-butadiene rubber (SBR) and the like can be exemplified.

Also, the configuration of the electrolyte is not particularly limited. The electrolyte can be an aqueous electrolyte solution, and can be a non-aqueous electrolyte solution. Between the two, the aqueous electrolyte solution is preferably used. The aqueous electrolyte solution contains electrolyte salt and water. As the electrolyte salt, a known electrolyte salt having solubility to water and expressing desired ion conductivity can be adequately used, and it is preferred that at least one kind or more of alkali metal (s) and alkali earth metal(s) is/are contained in the electrolyte salt. As the electrolyte salt, LiOH, KOH, NaOH, RbOH, CsOH, Ca(OH)₂, Sr(OH)₂ and the like can be exemplified.

Also, in a case where an electrolyte solution (liquid electrolyte) is used as the electrolyte, the electrolyte solution is preferably alkaline. The electrolyte preferably has a pH of 7 or more, and more preferably a pH of 12 or more.

The separator can have any configurations without particular limitations, and a known separator which can be used for an alkaline battery can be adequately applied. In specific, a porous film made of polyethylene, polypropylene, cellulose or the like, nonwoven fabrics such as resin nonwoven fabric, glass fiber nonwoven fabric and the like can be exemplified.

The anode current collector and the cathode current collector can have any configurations without particular limitations, and a known electroconductive material stable to the electrolyte which can be used for a current collector of a metal-air battery can be adequately applied. The anode current collector and the cathode current collector are preferably formed of an electroconductive material provided with a metal layer (covering layer) containing at least one or more selected from the group consisting of Ni, Cr, and Al formed on a surface of the electroconductive material, a metallic material whose entire body consists of a metal containing at least one or more selected from the group consisting of Ni, Cr, and Al and the like. By using an electroconductive material and metallic material like the above, it becomes possible to prevent reaction of the current collector and the electrolyte, whereby it is possible to make a configuration in which the electrolyte is easily prevented from leaking. Also, the anode current collector and the cathode current collector can have a known configuration such as mesh shape if needed.

The water-repellent membrane can have any configurations without any particular limitations, and a known water-repellent membrane which can bring oxygen to the cathode of a metal-air battery and can prevent the electrolyte from leaking can be adequately employed. As the water-repellent membrane, in addition to porous fluororesin sheets (porous polytetrafluoroethylene (PTEE) sheet and the like), porous celluloses and the like can be exemplified.

The housing can have any configurations without particular limitations, and can be made from a known substance stable to the electrolyte. As the substance, a member provided with a metal layer (covering layer) containing at least one or more selected from the group consisting of Ni, Cr, and Al formed on a surface of the member, a metal containing at least one or more selected from the group consisting of Ni, Cr, and Al, resins represented by polypropylene (PP), polyethylene (PE) and acrylic resin and the like can be exemplified. A side face of the housing is provided with a hole (s) to lead the air existing around the housing to inside of the housing if needed.

In the above explanation, an iron-air primary battery is exemplified as the metal-air battery of the present invention. However, the metal-air battery of the present invention is not limited to this configuration. The metal-air battery of the present invention can have another configuration such as a configuration of zinc-air primary battery, aluminum-air primary battery, magnesium-air primary battery, depending on the metal to be used for the anode active material.

In the above explanation, a configuration in which only the anode is ejected (changed out) is exemplified. However, the metal-air battery of the present invention is not limited to this configuration. The metal-air battery of the present invention can have a configuration in which the electrolyte is changed out in addition to the anode. Ina case where the carbon dioxide absorbent is not used, it is considered that the electrolyte is preferably changed out with the anode since the ion conductivity of the electrolyte is easy to degrade. In contrast, in the present invention, it is possible to inhibit degradation of the ion conductivity of the electrolyte since the carbon dioxide absorbent is used. Therefore, in the present invention, even though only the anode is changed out without changing out the electrolyte, it is possible to inhibit deterioration of the battery performance.

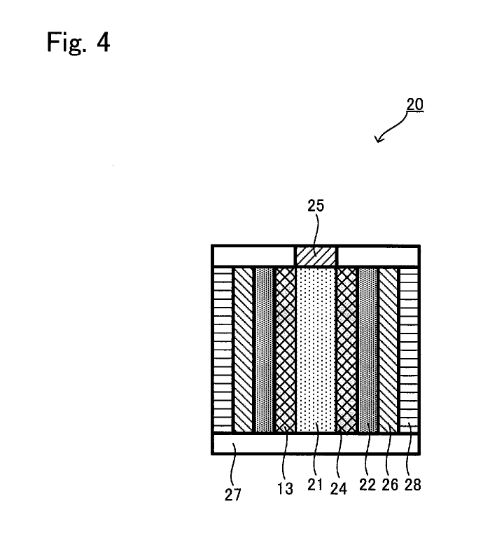

In a case where a sheet-shaped anode (in a form of plate) is employed to the present invention, the metal-air battery of the present invention, for example, can have a configuration in which: a structure body including a laminated body formed by laminating a sheet-shaped anode, a sheet-shaped separator, and a sheet-shaped cathode in the order mentioned; and an electrolyte are housed in a housing. Also, in the present invention, in a case where the anode has a tubular shape (stick shape), the metal-air battery of the present invention, for example, can have a configuration in which: a structure body including a tubular anode, a separator disposed in a manner to surround the anode, and a cathode disposed in a manner to surround the separator; and an electrolyte are housed in a housing. An example of the metal-air battery having this configuration is shown in FIG. 4. In FIG. 4, for elements configured in the same way as in the constituent elements in FIG. 2 or FIG. 3, the same symbols are applied as the symbols used in the FIGS. 2 and 3, and explanations thereof are adequately omitted.

A metal-air battery 20 shown in FIG. 4 includes an anode 21, a separator 24 formed in a tubular shape and disposed around the anode 21, a cathode 22 formed in a tubular shape and disposed around the separator 24, an electrolyte solution 13 filling pores of the separator 24, an anode current collector 25 connected to the anode 21, a cathode current collector 26 disposed around the cathode 22, and a housing 27 housing the anode 21, the separator 24, the cathode 22, the electrolyte solution 13, the anode current collector 25, and the cathode current collector 26, wherein a part of the housing 27 is configured by a water-repellent membrane 28. The anode 21 has a tubular shape and is configured such that the anode 21 can be ejected from the housing 27. The cathode 22 has a configuration in which a catalyst which makes reactions of oxygen (cathode active material) easy to occur in the cathode 22 is held by an electroconductive member by means of a binder. The separator 24 is a porous member made of resin, the separator 24 having gaps and holes where the electrolyte solution 13 can be retained. The anode current collector 25 and the cathode current collector 26 are used for example when the electricity is taken out to the outside. Also, the housing 27 is configured such that the air existing around the housing 27 can diffuse to the cathode 22 via the water-repellent membrane 28 which configures a part of the housing 27. The metal-air battery 20 is configured such that, by means of the water-repellent membrane 28 and the like, the electrolyte solution 13 does not leak from the housing 27. The metal-air battery 20 configured as described also can exert the same effect as in the battery 10, since it includes the anode 21 including the anode active material 11a, carbon dioxide absorbent 11b, and the electroconductive holding body 21c.

### DESCRIPTION OF THE REFERENCE NUMERALS

10, 20 metal-air battery
11, 21 anode
11a anode active material
11b carbon dioxide absorbent (CO₂ absorbent)
11c, 21c electroconductive holding body
12, 22 cathode
13 electrolyte
14, 24 separator
15, 25 anode current collector
16, 26 cathode current collector
17, 27 housing
18, 28 water-repellent membrane

1. A metal-air battery comprising:
an anode;
a cathode;
an electrolyte disposed between the anode and the cathode; and
a housing configured to house the anode, the cathode, and the electrolyte,
wherein the anode is capable of being ejected from the housing and the anode includes an anode active material, a carbon dioxide absorbent, and an electroconductive holding body configured to hold the anode active material and the carbon dioxide absorbent.

2. The metal-air battery according to claim 1, wherein the carbon dioxide absorbent is one or two or more substance(s) selected from the group consisting of MgO, soda lime, soda asbestos, Li₂ZrO₃, Li₄SiO₄, calcium oxide, hydrotalcite-like compounds, zeolites, metal-organic frameworks, Li₂O, and Na₂O.

3. The metal-air battery according to claim 1, wherein the carbon dioxide absorbent is one or two or more substance(s) selected from the group consisting of lithium hydroxide, calcium hydroxide, and sodium hydroxide, and the electrolyte is a different substance from the carbon dioxide absorbent.

4. The metal-air battery according to claim 1, wherein:
the carbon dioxide absorbent is one or two or more substance(s) selected from the group consisting of lithium hydroxide, calcium hydroxide, and sodium hydroxide;
the electrolyte includes a same substance as the carbon dioxide absorbent; and
an amount of salt dissolved in the electrolyte is over saturated.

5. The metal-air battery according to claim 1, wherein the anode active material includes at least one or more selected from the group consisting of Fe, Zn, Pb, Sn, Cd, Al, Mg, and Ca.

6. The metal-air battery according to claim 1, wherein the electrolyte is an aqueous electrolytic solution and the aqueous electrolytic solution contains an electrolyte salt selected from the group consisting of LiOH, KOH, NaOH, RbOH, CsOH, Ca(OH)₂, and Sr(OH)₂.

7. The metal-air battery according to claim 1, wherein a cathode active material making electrochemical reaction in the cathode is oxygen.
